(19) United States
(12) Patent Application Publication
(10) Pub. No.: US 2016/0371956 A1
(43) Pub. Date: Dec. 22, 2016

(54) Temp Pal

(71) Applicant: Jared Henry, Overland Park, KS (US)

(72) Inventor: Jared Henry, Overland Park, KS (US)

(21) Appl. No.: 14/742,356

(22) Filed: Jun. 17, 2015

(51) Int. Cl. G08B 21/18; G01J 5/10; G01K 7/22; G01K 1/14; G01K 1/02

(52) U.S. Cl. CPC G08B 21/182; G01K 1/14; G01K 1/02; G01K 7/22; G01J 5/10

(57) ABSTRACT

A beverage temperature-monitoring device that is comprised of a supporting member that adapted to mount on rim of the container that holds the beverage, a heat sensor coupled to inner arm of the supporting member and is in continuous contact with the beverage, a dashboard coupled to outer arm of supporting member and operably coupled to the heat sensor. The dashboard includes an integrated display screen to show the actual and desired temperature set by user and have input means to set the desired temperature. The dashboard further includes the audio and visual indicators to alert the user when the temperature of the beverage reaches the desired temperature.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable

### BACKGROUND OF THE INVENTION

(1) Field of the Invention

The present invention generally relates to a temperature-monitoring device. More specifically, the invention relates to a device that monitors the temperature of a beverage and alerts the user when the temperature of the beverage reaches a desired temperature.

(2) Background of Invention

Hot beverages, such as coffee or tea, are typically kept standing for some time to bring down the temperature of beverage to a drinkable temperature. It is common that an individual may mistakenly sip the hot beverage, resulting in burning of the mouth. Moreover, it is difficult to ascertain the temperature of the beverage simply by holding the cup or similar vessel containing the beverage. Also, it often happens that a person keeps the beverage to cool down and simply forgets about the beverage. When the person remembers the beverage, the beverage has become too cold to drink. The person may either warm the beverage again, or leave it. Both processes lead to wastage of time or cost of beverage.

Thus, it is desirable to provide a device that monitors the temperature of the beverage and alerts the individual when the desired temperature is achieved. Using such a device, the users will no longer burn their mouths on coffee that is too hot to drink. They could engage in other activities while the hot beverage cools down to a drinkable temperature without requiring the user's continuous attention. Prior art attempts to overcome the above issues by providing devices that monitor the beverage temperature and generate alerts when the beverage temperature reaches a drinkable temperature range. For example, U.S. Pat. No. 7,766,545, entitled “Safety lid and method for use of same,” discloses a safety lid for use with a drinking cup. The safety lid includes means to measure the temperature of a hot beverage and, if the measured temperature is outside predetermined temperature range, close the fluid passageway in the lid.

Another, U.S. Patent appl. No. 20040247015, entitled “Beverage and food temperature notification device,” discloses a device to monitor the temperature of baby beverages and foods. The device could be mounted in the container containing the beverage, and includes a probe for continuously monitoring the temperature of the beverage. On reaching the desired temperature range, an audio and visual signal alerts the user.

The devices of the prior art overcome the aforesaid issues to some extent; however, the devices suffer from one or more shortcomings, which limit their use and render the device commercially disadvantageous. One such disadvantage of prior art devices is the inbuilt nature of the device into the container, which limits the use of device to the beverage that could be contained in the container. Also, most of the devices of the prior art do not allow the user to set the desired temperature. Thus, a need is appreciated for a beverage temperature monitoring device that could be removably attached to the beverage container and allow users to set the desired temperature.

### BRIEF SUMMARY OF THE INVENTION

The present invention, therefore, has as its principal objective to provide a device to monitor the temperature of beverage.

Another objective is that the device could be removably attached to the container holding the beverage.

An additional objective is that the device allows user to set the desired temperature.

A further objective is that the device displays the actual and desired temperature.

A still further objective is that the device provides audio and visual alerts when the temperature of the beverage reaches the desired temperature.

A still further objective is that persons of all ages and genders could use the device.

Yet another objective is that the device is economical to manufacture and simple to use.

Certain embodiments of current invention provide a beverage temperature-monitoring device that could be used to measure the temperature of a hot beverage, such as, but not limited to, coffee or tea. The device is comprised of a heat sensor, which could be a thermometer, IR sensor, or thermistor. The heat sensor is coupled to a support member, which is an elongated arm that is curved in its upper portion such that the supporting member could be clipped on the rim of the container containing the beverage. A portion of the elongated arm lies inside (inner arm) and outside (outer arm) of the container. Each part extends from the middle portion at the top of the container. The middle portion of the support member could be U-shaped or linear, with the two arms bent at 90 degrees. The length of inner and outer arm could be different, and the heat sensor couples to the inner arm, which is in contact with beverage. The heat sensor could be operably coupled to a dashboard that is mounted on the outer arm of the support member. The dashboard includes a display screen to show actual and desired temperatures, plurality of input means, such as push buttons to feed the desired temperature, and audio and visual alert generating units.

In addition to the various objectives and advantages of the present invention, described with some degree of specificity above, it should be obvious that additional objectives and advantages of the present invention will become more readily apparent to those persons who are skilled in the relevant art from the following more detailed description of the invention, particularly when such description is taken in conjunction with the attached drawing figures.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 is a perspective view of the beverage temperature-monitoring device.

FIG. 2 is a front view of the dashboard of the beverage temperature-monitoring device.

FIG. 3 is a side view of the beverage temperature-monitoring device mounted in the beverage container.

### DETAILED DESCRIPTION OF THE INVENTION

Before explaining at least one embodiment of the invention in detail, it is to be understood that the invention is not limited in its application to the details of construction and the arrangements of the components set forth in the following description. The invention is capable of other embodiments, and of being practiced and carried out in various ways. Also, it is to be understood that the phraseology and terminology employed herein are for the purpose of description, and should not be regarded as limiting.

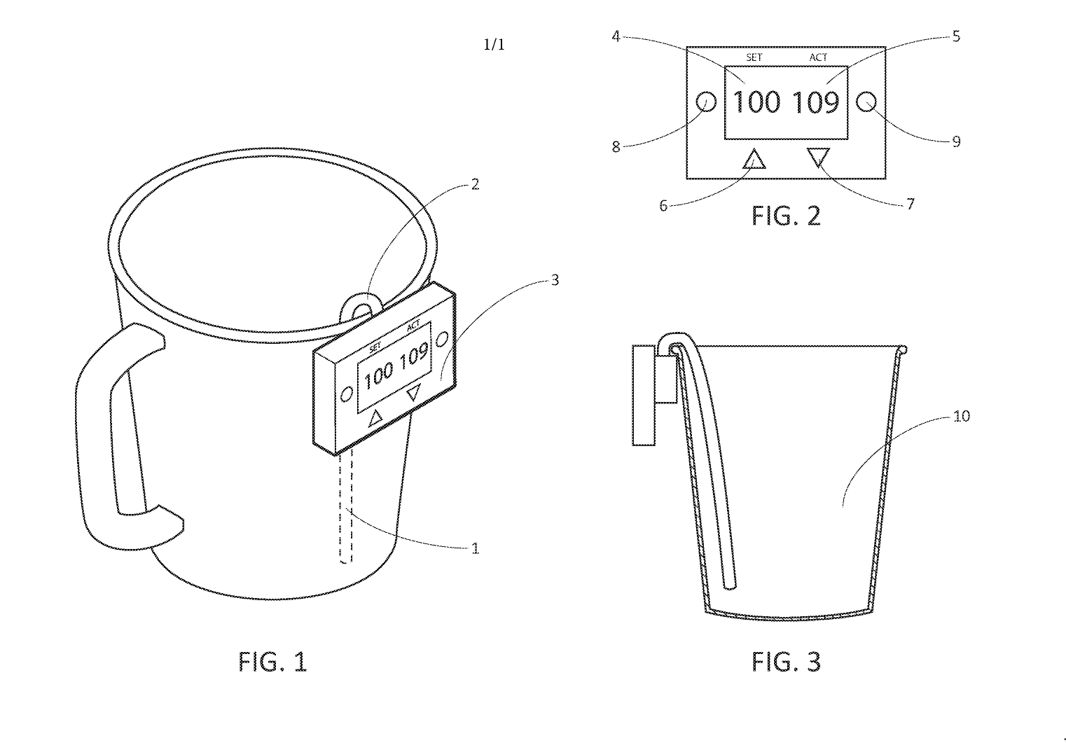

FIG. 1 illustrates that the present invention is a beverage temperature-monitoring device that could be used to detect and monitor the temperature of a beverage, such as tea or coffee. The device includes a heat sensor, which measures the temperature of the beverage. The heat sensor could be in continuous contact with the beverage for real-time monitoring of the temperature of the beverage. The heat sensor could be a thermometer, an IR sensor, or a thermistor that is operable in the range of temperature of the beverage. For example, a beverage that is primarily water could have the highest temperature near the boiling temperature of the water, i.e. 100 degree Celsius. Thus, a heat sensor for monitoring the water containing beverage should be operable in range from 10-150 degree Celsius temperature.

The heat sensor may have a protective covering to protect the sensor from the beverage and that provides for convenient washing of the sensor for reuse. The heat sensor is coupled to a supporting member 1 of the device. The supporting member could be an elongated arm made of metal or plastic. The elongated arm is curved near the middle portion 2 to form a U-shaped figure. The U-shaped supporting member could be hung on the rim of the container that holds the beverage. FIG. 3 shows the device mounted on the rim of the container 10. The container could be any vessel holding a beverage, such as a coffee mug, traveler mug, teacup, or a drinking water glass. The portion of the arm extending inside of the container could be of length different from the outside portion of the arm. The length of inner arm is such that the heat sensor coupled to the end of the inner arm remains in continuous contact with the beverage. Preferably, the inner arm could extend to the middle portion of the container.

The supporting member could preferably be made of heat resistant material that is easy to clean. The supporting material could be made of flexible material that allows a user to bend the elongated arm according to his requirement and clamp it onto the container. The bended supporting member could be again flattened by applying pressure through hands. This allows the supporting member to be used for containers of different sizes.

The heat sensor could be operably coupled to a dashboard 3, which receives the detected temperature from the heat sensor and digitally displays the detected/actual temperature of the beverage on an integrated display screen 4 and 5. The dashboard could be mounted on the outer arm of the supporting member, and could be of any shape, such as cuboid or ellipsoid. The dashboard is preferably enclosed in a protective covering. The dashboard includes a controller that processes the electrical signals that are received from the heat sensor for displaying on an integrated display screen. The screen could be LCD, or any other type of display screen obvious to a skilled person for displaying numerical figures in digital format. The dashboard 3 may further include push buttons 6 and 7, as shown in FIG. 2. The buttons could be used to set the desired temperature. The desired temperature could be in a range of drinkable temperature, or, any other temperature desired by the user. The user may use a button 6 to move the temperature up, and a button 7 to move the desired temperature down. Instead of push buttons, touch interface could be provided to set the desired temperature. The assembly and functioning to set temperature are obvious to a skilled person, and any interface or arrangement of buttons could be incorporated into the device.

The display screen 5 shows both the set temperature and actual temperature for user viewing. To use the device, a user sets the desired temperature using the push buttons, and clips the device onto the rim of the container such that inner arm of the supporting member dips into the beverage. The device includes an audio generator unit, which could be a speaker. The audio driver generates sound pulses or beeps to alert the user when the temperature of the beverage reaches the temperature set by the user. Besides audio alerts, the device may further include visual signals, such as LED indicators. As shown in FIG. 2, the device incorporates LED's 8 & 9. The Led 5 could be of red color, and indicates that the temperature of the beverage is outside of the temperature set by the user. The other LED 8 could be of green color, which optionally flashes, and indicates that the temperature of beverage has reached the desired temperature and that the beverage is ready for consumption by the user.

Portable and compact batteries could power the device, which may be replaceable or rechargeable. Optionally, the device may contain solar energy generating units. The support member of the device could be of any shape and size that allows convenient clamping of the device onto the walls of the container. In the preferred embodiment, the support member could be U-shaped, as shown in FIG. 3, or the top portion of support member could be linear. Obviously, the structure of the support member could vary depending on the different size of the containers, such that the supporting member may be manufactured in different sizes with different dimensions to ensure a convenient attachment to the container. The sizes and shapes provided are typical of one preferred embodiment only. Those skilled in the art will be able to make the necessary size and shape adjustments for different situations.

Those skilled in the art should appreciate that they can readily use the disclosed conception and specific embodiment as a basis for designing or modifying other structures for carrying out the same purposes of the present invention, and that such other structures do not depart from the spirit and scope of the invention in its broadest form.

1. A beverage temperature-monitoring device to detect and monitor the temperature of a beverage, wherein the device comprises:
a. a supporting member that is adapted to mount on the rim of a container containing said beverage, said support member is comprised of an inner arm and an outer arm, said inner arm extends downwards inside of the container, said outside arm extends downwards outside of the container;
b. a heat sensor coupled to the inner arm of said supporting member, said heat sensor is configured to be in continuous contact with the beverage for real time monitoring of the temperature of the beverage;
c. a dash board coupled to the outer arm of said supporting member, said dash board is operably coupled to the heat sensor and is comprised of:
i. a display screen to show temperature;
ii. an input means to set the desired temperature;
iii. an audio driver to generate audio alerts;
iv. a plurality of visual indicator for visual alerts;
v. a power suppliant unit to power the beverage temperature monitoring device;
said audio driver and visual indicators generate the alerts when temperature of the beverage reaches the desired temperature;

2. The beverage temperature-monitoring device of claim 1, wherein said beverage is a coffee.

3. The beverage temperature-monitoring device of claim 1, wherein said beverage is a tea.

4. The beverage temperature-monitoring device of claim 1, wherein said visual indicator is a LED.

5. The beverage temperature-monitoring device of claim 1, wherein said display screen is a LCD screen.

6. The beverage temperature-monitoring device of claim 1, wherein said input means is a push button.

7. The beverage temperature-monitoring device of claim 1, wherein the power supply unit is a battery.

8. The beverage temperature-monitoring device of claim 1, wherein said power supply unit is a solar energy-generating unit.

9. The beverage temperature-monitoring device of claim 7, wherein said battery is rechargeable.

10. The beverage temperature-monitoring device of claim 1, wherein said heat sensor is a thermometer.

11. The beverage temperature-monitoring device of claim 1, wherein said heat sensor an IR sensor.

12. The beverage temperature-monitoring device of claim 1, wherein said heat sensor is a thermistor.

13. The beverage temperature-monitoring device of claim 1, wherein said container is a coffee mug.

14. The beverage temperature-monitoring device of claim 1, wherein said container is a traveler mug.

15. The beverage temperature-monitoring device of claim 1, wherein said container is a tea cup.

16. The beverage temperature-monitoring device of claim 1, wherein said container is a water glass.
